(19) United States
(12) Patent Application Publication
(10) Pub. No.: US 2006/0232409 A1
(43) Pub. Date: Oct. 19, 2006

(54) Alarm system using radio frequency identification tags

(75) Inventors: Tom Gray, Mansfield (CA); Paul Bertrand, Pembroke (CA)

Correspondence Address: DAVID L. KING, SR., 5131 N.E. COUNTY ROAD 340, HIGH SPRINGS, FL, 32643, US

(73) Assignee: PhoneGuard Security

(21) Appl. No.: 11/108,256

(22) Filed: Apr. 18, 2005

(51) Int. Cl. G08B 1/08

(52) U.S. Cl. 340/572.1; 340/539.1

(57) ABSTRACT

An alarm system for detecting intrusion into a premises having telephone service over a telephone line, comprising a plurality of wireless sensors arranged in an area to be monitored for generating unique coded wireless signals indicating an alarm condition upon detection of an intrusion, and an alarm module connected to the telephone line for detecting the unique coded wireless signals and in response causing at least one telephone to ring and to provide notification of the alarm condition on a specified one of the sensors.

### FIELD OF THE INVENTION

The present invention is directed to intrusion alarm systems, and more particularly to a low-cost home alarm system utilizing radio frequency identification (RFID) tags and existing telephone wiring.

### BACKGROUND OF THE INVENTION

The issue of security is of great concern to most home owners. Fear of home invasions and burglaries cause people to feel insecure in their own homes. As a result there is a large market for home security systems that can protect the occupants and property of a home from unauthorized intrusion. Unfortunately, most commercially available systems are too costly for a significant portion of the population.

The following US patents are exemplary of the art: U.S. Pat. No. 5,646,592, U.S. Pat. No. 6,025,780, U.S. Pat. No. 6,577,238, U.S. Pat. No. 6,057,764, U.S. Pat. No. 6,525,648, U.S. Pat. No. 6,608,551, U.S. Pat. No. 6,396,413, U.S. Pat. No. 6,609,656, U.S. Pat. No. 6,172,596, U.S. Pat. No. 6,456,239 and U.S. Pat. No. 6,646,550.

### SUMMARY OF THE INVENTION

It is an aspect of the present invention to provide a simple, low-cost alarm system suitable for residential use, which overcomes disadvantages inherent in the prior art. More particularly, according to an aspect of the invention a low-cost home security system is provided that uses the existing telephone wiring which is ubiquitous in homes and small business premises, and recent developments in RFID technology.

In terms of cost reduction, the present invention makes use of existing telephone infrastructure that is present even in the most modest residences. The alarm control pad, which is a costly component of a specialized alarm system, is replaced by a telephone DTMF key pad, so as to take advantage of the massive economies of scale that are present within the telephone industry and the massive amounts of product research and development that has gone on to minimize the cost of telephone sets.

The same is true of the RFID technology used in the present invention. Large R&D investment is being allocated to lower the cost of RFID devices for commercial and industrial applications. The low cost alarm system of the present invention thus leverages economies of scale that are far beyond anything that could be justified for a dedicated alarm technology.

The integration of alarm functionality with telephone technology creates benefits that go beyond cost savings. The integration creates the conditions for the creation of services that enhance the existing customer values provided by alarm and telephone systems and provide a novel value as well.

Alarm systems serve multiple purposes. Commonly, home and small business systems are sold for perimeter protection. Perimeter systems monitor a specific area (home, small business premises etc.) for intrusions. Such systems are used to provide protection of valuable goods when the location is unoccupied. The alarm system will sound a siren or some other device to scare away an intruder and report the alarm to a monitoring service or police force. This gives rise to a customer value that may be referred to as ‘protection of valuables’.

Another function of perimeter alarm systems is to provide personal protection. For personal protection, the system alerts people located in the protected area of an intrusion, fire etc. The alerted people can then independently decide to take action to protect themselves. This gives rise to a customer value that may be referred to as ‘personal protection’.

There is a unique customer value that results from the integration of alarm and telephone technology as provided by the present invention, which may be referred to as ‘peace of mind’ value. Consider the case of the adult children of an aged mother who is living alone in her own apartment. These children are naturally concerned about the possibility that their mother could be in a situation in which she needs urgent help but is unable to obtain it. A product or service which provides them with assurance of their mother's situation would give ‘peace of mind’. The combination of telephony and alarm technology according to the present invention provides conditions for alarms that are not found in conventional systems. For example, the system can be programmed to monitor the telephone to ensure that it has been used within a period of time. Interior or cupboard doors can be monitored to detect activity within the residence. These types of alarms are not found on conventional systems, and can be used not only to detect malicious activity by outsiders, but also to detect the normal and expected activity within a home, and thereby give rise to ‘peace of mind’.

The novel combination of alarm and telephony services also provides the capability of providing a combined service that allows a small business or home owner to save money. Small businesses very often purchase telephone dialers to monitor and control the telephone usage within their businesses. For example, a dialer can be used to restrict long distance usage on business lines, as a cost control measure. Small business owners also commonly buy burglar alarms. The system according to the present invention can be used to create a single product which supplies both dialer and alarm needs, with the obvious cost savings to the owner.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

The invention will be described by way of example and with reference to the accompanying drawings in which:

FIG. 1 is a block diagram of an alarm system according to one embodiment of the invention.

FIG. 2 is a block diagram of an alarm module of the system shown in FIG. 1.

FIG. 3 is a block diagram of an alarm monitor of the system shown in FIG. 1.

FIG. 4 is a block diagram of a first implementation of the alarm system according to the invention.

FIG. 5 is a block diagram of a second implementation of the alarm system according to the invention.

FIG. 6 is a block diagram of a third implementation of the alarm system according to the invention.

FIG. 7 is a block diagram of a fourth implementation of the alarm system according to the invention.

### DETAILED DESCRIPTION OF THE INVENTION

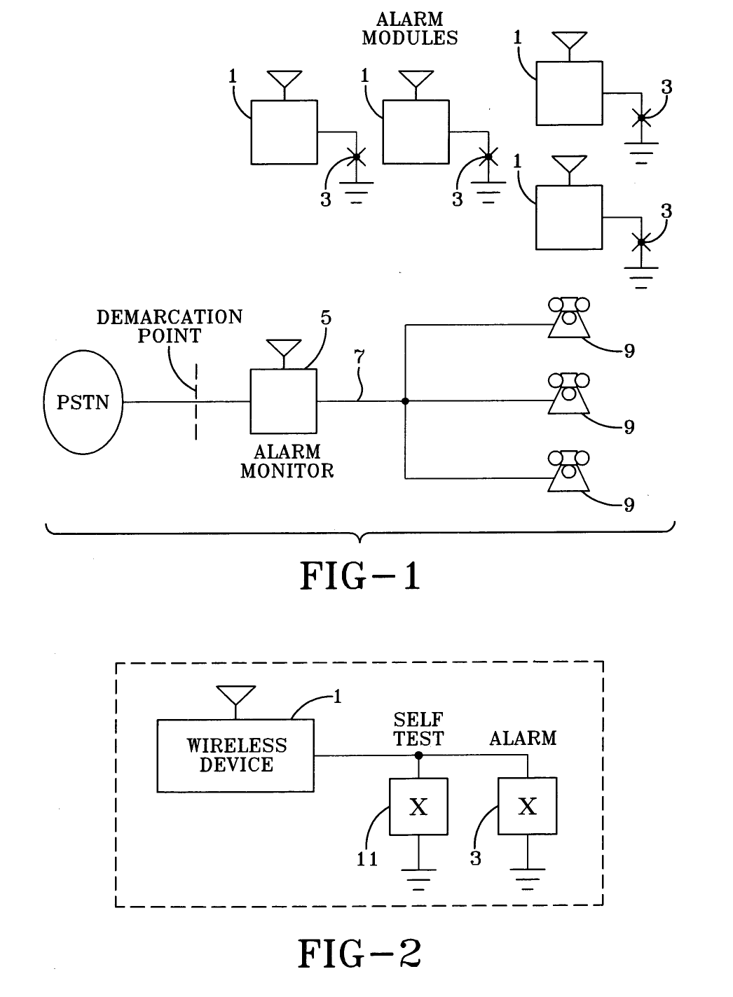

A block diagram of one instantiation of the system is shown in FIG. 1. Several other configurations are possible with various implications for cost, powering etc. However, in any such configuration, beacon RFID technology and the signaling capability of the telephones existing inside the home is used to limit cost.

In the system of FIG. 1, a plurality of RFID beacons 1 are coupled with commonly available alarm sensors 3 and placed at the various entrances, windows etc. of the residence to be monitored. Each beacon 1 emits a unique RFID identity code when activated by its associated alarm sensor 3. This code is detected by an alarm monitor 5, where the code signal is de-bounced (i.e. a persistent ID is used as an indication of an alarm). The monitor 5 then places a special ringing signal on the telephone lines 7 to indicate that an alarm condition is present.

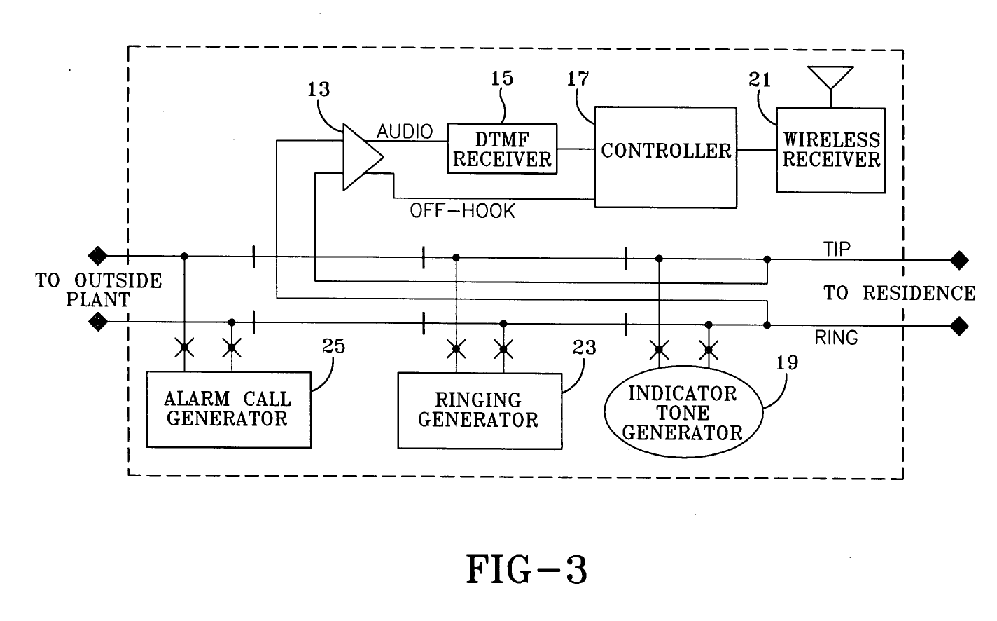

The connection of alarm monitor 5 to the telephone system provides an economical mechanism for programming and controlling the system. As discussed in greater detail below, the monitor 5 includes a DTMF receiver (FIG. 3) for detecting a special DTMF code sequence on the line 7 when a telephone 9 is off-hook. This code sequence places the monitor 5 in programming mode for adding alarm modules to the system, arming the system, etc.

A block diagram of an alarm module is shown in FIG. 2, comprising a standard RFID beacon 1 with commercially available sensor 3 for detecting alarm conditions. RFID beacons are well known, as an example, for use in manufacturing processes.

The RFID device 1 may be programmed with a unique identity code and other needed information. This programming of the identity code may either be done wirelessly during operation of the device or as a factory option. The device 1 may be programmed to wirelessly transmit the unique programmed ID and other information either at random time intervals or upon actuation of switches 3 or 11. Switch 3 is an alarm sensor, as described in greater detail below, and switch 11 is a self-test button, also described in greater detail below.

One example of alarm sensor 3 is a commonly available magnetic door contact. The opening of a door in a secured environment closes the switch 3 which causes the RFID device 1 to begin transmitting its identity code. The identity code is interpreted by the alarm monitor 5 as an alarm indication.

The RFID device 1 can also be programmed to transmit its ID code at random intervals, as discussed above, to ensure that the alarm module is operational and has battery power.

Moreover, as discussed above, the RFID device 1 may also be commanded to transmit its ID code by the operation of self-test button 11 for verifying that the alarm monitor 5 is in communication with the device 1. As discussed in greater detail below with reference to FIG. 3, when programming the system, the alarm monitor 5 listens for any RFID identity code generated by operation of the self-test button 11 and in response adds the associated RFID device 1 to the system. Also, the alarm module of FIG. 2 may be placed in the alarm condition by means of activating self-test switch 11 and recognition of same by the alarm monitor 5.

A block diagram of the alarm monitor is shown in FIG. 3. The monitor is installed so as to bridge the telephone line 7 at a convenient point (i.e. demarcation). A tip and ring sensor 13 of conventional design senses the off-hook state of the line and captures any audio signal on the line. The audio signal is applied to a DTMF receiver 15 and the off-hook indication is supplied to a conventional controller 17. A tone generator 19 is provided for the controller 17 to convey an alarm state to the telephone(s) 9 and also to signal status in programming. An RFID receiver 21 detects any transmitted alarm IDs and applies these to the controller 17. The controller also controls switching of a ringing generator 23 onto the line through relay contacts, for alerting the user of an alarm condition.

Alarm notification can be done either with or without voice announcement. With no voice announcement, in the event of an intrusion, the activated RFID sensor 1 notifies alarm module 5. Specifically, upon closure of the contact 3, RFID device 1 begins transmitting its unique ID code, which is detected by the wireless receiver 21 and provided to the controller 17. The controller operates a relay for isolating the ringing generator 23, thereby causing the telephone(s) 9 on the line to ring using a special ringing pattern indicative of an alarm condition. Preferably, the ringing pattern differs from a conventional telephone call-ringing pattern in order to distinguish an alarm condition from an incoming telephone call. For example, in the alarm state, the telephone(s) may be caused to ring continuously or alternatively to ring with another distinctive ringing pattern.

Upon hearing the distinctive telephone ringing pattern, a user will normally answer the closest telephone 9 (i.e. go off-hook). The off-hook state is by detected by the tip and ring sensor 13 and an off-hook signal is provided to the controller 17. The controller then removes the ringing generator 23 from the loop and connects the tone generator circuit 19. The controller then causes the tone generator to transmit a code such as a series of beeps or other format of signal to indicate to the user which of the plurality of alarm sensors 1 has been triggered. Tip and ring sensor 13 detects the user going back on hook and notifies the controller 17, which in response removes the tone generator 19 and restores the telephone line 7 to its normal state.

If the user fails to go off-hook after a specified period of distinctive ringing, an outgoing call is automatically placed to a pre-programmed telephone number (e.g. a work number, friend's telephone number, etc). The call is initiated by alarm call generator 25 under control of the controller 17. After dialing the pre-programmed telephone number, the tone generator 19 transmits a coded signal (e.g. the pattern of beeps discussed above) for alerting any person answering at the dialed number of the alarm condition at the user's premises. The alarm condition (i.e. pattern of beeps) persists for a period of time that is sufficient for the call to have been answered.

The called party may use the common PSTN (Public Switched Telephone System) feature of “forced disconnect” to remove the outgoing alarm call from the connection. The forced disconnect feature is almost universally available on most PSTNs to permit a called telephone to be disconnected within 30 seconds of that telephone going on hook. This feature is normally provided as a protection against obscene or other types of harassing calls.

With the voice announcement feature enabled, the ringing generator 23 of FIG. 3 and its associated relay may be omitted. The indicator tone generator 19 is configured to include a sound generator having the capability of playing recorded speech. Tone generator 19 is also provided with an amplifier and loudspeaker.

In the case of an intrusion or other alarm condition, the RFID device operates in the same manner as described previously in connection with the no-voice announcement case. The indicator tone generator is then instructed to play a recording through its loudspeaker in order to indicate an alarm condition. This recording may be a generic message such as “Alarm, Alarm . . . ”, a fixed message dependent on the identity of the alarm triggered such as “Alarm 16, Alarm 16 . . . ”, or a recorded message created by the user such as “Door Alarm Triggered”. As discussed above, the message is issued for a specified period of time and may be silenced by taking the associated telephone off-hook. If the alarm is not silenced by user action, then an outgoing call may be made and an announcement similar to those described above may be played into the voice transmission stream of the telephone call.

As an alternative implementation for the voice announcement, an outgoing call may be made at the same time that the alarm is initiated. This may be specified as a user option or as a fixed part of the device.

In order to program the alarm system, the user is provided with a special DTMF code that, when dialed into a telephone 9, causes the system to go into programming mode. Upon going off-hook, the controller 17 isolates the line 7 from the PSTN central office (CO) and connects tone generator 19. The controller monitors the line via receiver 15 for the user's special DTMF code (e.g. a unique tone sequence that is preceded by a ‘*’ or a ‘#’). The controller signals acknowledgement of the code and entry into the programming mode by the generation of a further specific beep pattern via the tone generator 19.

In order to add an alarm module to the system (after having entered the programming mode), the user first presses the associated self-test button 11. The controller 17 monitors the wireless environment for the detection of an ID code for the new module. Any ID code that the controller receives while in the programming mode is deemed to be the one that should be monitored for alarm state. This feature addresses the problem of multiple alarm systems operating in the vicinity of each other and reacting to each other's alarms, and allows for independent operation of multiple adjacent systems (e.g. such as in an apartment building).

For the case where programmable voice announcements are to be enabled, the user goes off-hook and enters a series of DTMF tones or other signals to instruct the indicator tone generator 19 to record an alarm announcement for a specific alarm module. For example, the user may record a meaningful designation for an alarm such a “Back Door Open”.

FIGS. 4, 5 and 6 show alternative implementation configurations for the alarm monitor of the present invention.

In FIG. 4, a discrete module is provided at the demarcation point at which the PSTN external plant is brought into the user's premises. This configuration has the advantage of providing the monitoring function at all telephones within the premises, but suffers from the disadvantage of requiring special installation (both for power and telephone access).

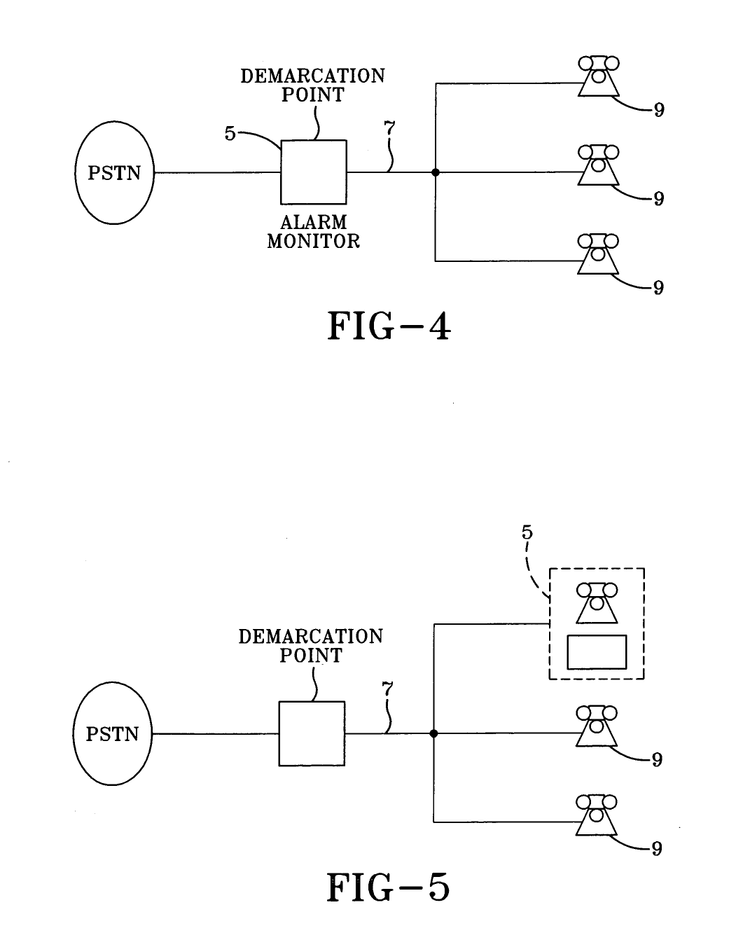

FIG. 5 is a configuration in which the wireless alarm module is integrated with a telephone situated in a bedroom (or some other location in which the protected people sleep or undertake other vulnerable activities). The alarm alerts the associated telephone and is programmable from the area of installation. This configuration emphasizes low cost.

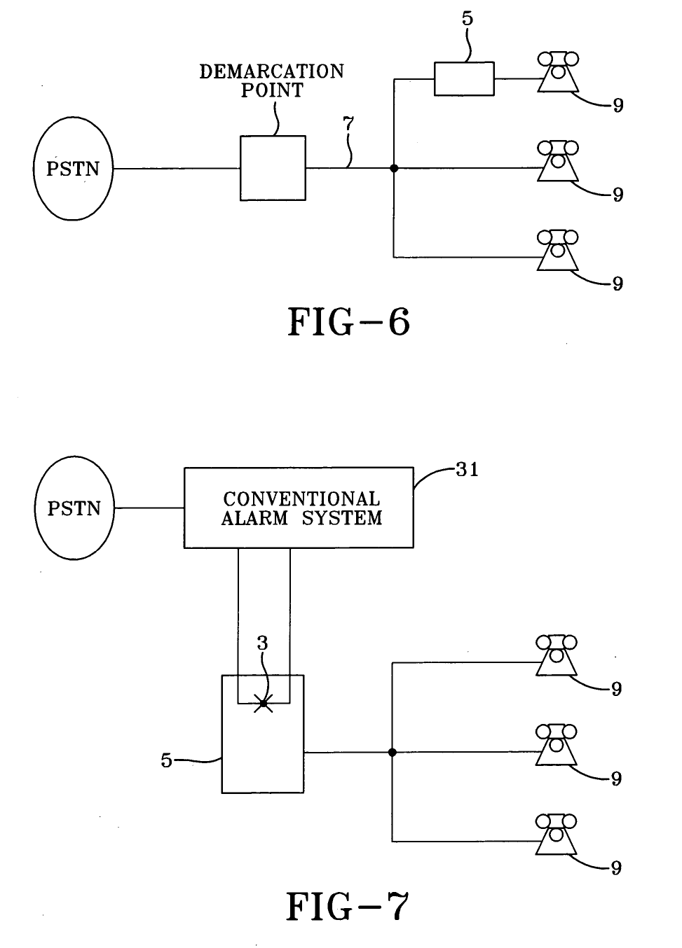

FIG. 6 is an illustration of a configuration in which a separate alarm module is supplied with jacks so that it may be placed in series with the telephone. As in the integrated telephone configuration of FIG. 5, this configuration alerts and is controlled from one area such as the bedroom, and is characterized by low cost.

In conventional alarm systems, reported alarms are filtered in one of two ways. Firstly, alarms that protect entrances and exits are filtered temporally so that people may exit and leave the premises (i.e. ‘delayed filtering’). It is common in such systems to de-activate the alarms for 30 seconds after the alarm system has been armed, so that people can leave the protected area. Also, it is common to suspend alarm generation for 1 minute after triggering, when the alarm system has been armed, in order to allow sufficient time for a person to enter the protected area and deactivate the alarm.

An alternate mode (i.e. “instantaneous alarms”) is commonly used to protect windows and other areas through which people do not commonly enter or exit.

According to the present invention a plurality of additional modes are provided to afford the customer the aforementioned value of ‘peace of mind.’ These additional modes may be illustrated by way of example. Consider the case of a business in which there are sensitive areas which are in active daily (e.g. the liquor storage area of a restaurant, which is kept secure but will be accessed routinely by employees). It is customary for such areas to be secured by an access door that must be kept closed at all times except for ingress and egress. The conventional alarm filtering modes discussed above offer little benefit for such an application. Specifically, instantaneous filtering is unworkable while the need to deactivate the alarm system after each access would make delayed filtering unworkable as well. According to the present invention, the alarm system may be operated in accordance with a novel mode (referred to herein as ‘persistent filtering’), wherein a condition must persist for a specified period of time before an alarm will be triggered. With reference to the example above, if the door to the liquor storage area is left open permanently then an alarm is triggered. If, however, the door is opened and closed within a predetermined time period, for accessing the room, then no alarm is triggered. The business owner is thereby provided with ‘peace of mind’ regarding protection of his/her valuable stock.

Another operating mode according to the present invention (referred to herein as ‘activity filtering’) can be used in situations such as where an aged parent lives independently at home. Sensors may be placed on various internal items such as cupboard or refrigerator doors to which the aged person would normally and regularly have access. The sensors are deliberately placed in locations that are sensitive to the daily activity of the home. Alarm modules report activity in connection with these sensors to the central alarm monitor 5. The alarm monitor then generates an alarm only if the rate of activity falls below a specific rate. Consequently, the children of the aged person are provided with ‘peace of mind’ that normal activity is ongoing in their parent's residence.

A variant of activity filtering (referred to herein as ‘timed activity filtering’) causes generation of an alarm if a condition is not reported within a particular time interval. This is valuable, for example, in the care of “latch key children”. If these children do not return from school and enter the house within a specified time interval, the alarm system informs the parents or other guardians, thereby providing them with ‘peace of mind’.

The combination of telephony and alarm functionality provided by the system according to the present invention, gives rise to a system ‘awareness’ of activity in the daily life of a home. The system is aware of the off-hook status of the telephone or telephones 9 in a home and may be programmed to use this for various alarm purposes. In one instance, the use of a telephone 9 will indicate normal activity in the home. This use may be monitored as part of an activity filter for this purpose. Another example is a telephone that has gone permanently off-hook without a routable directory number having been dialed, giving rise to the possibility that a resident has been overcome while trying to telephone for help. This situation may be detected by the inventive system with a persistence filter and then reported in an appropriate programmable manner.

Small business owners are often provided with an alarm system configured for leased premises. The landlord typically supplies a common alarm system to multiple tenants. As indicated above, conventional alarm systems do not provide adequate ‘peace of mind’ value in such applications. FIG. 7 shows an implementation of the present invention whereby contact 3 closure triggers an alarm on the common alarm system 31. With this capability, an owner is able to take advantage of the unique types of customer value supplied by the present invention while at the same time using a conventional alarm system.

The combination of telephony and alarm functions in this system of the present invention allow for the combination of the functions of telephone dialer and alarm system, giving rise to additional economies since a small business owner will commonly purchase both of these devices. The ability of the system (e.g. as shown in FIG. 3) to monitor and modify DTMF signals from the user station allows it to function as a telephone dialer. Telephone dialer functionality, such as restrictions on access to toll lines, 900 number barring, etc., can be added to the programming of this system according to the present invention. Cost saving may be enjoyed by the combination of these functions in a single device.

The present invention has been described with respect to an RFID implementation. However, RFID is not essential to the invention. For example, it is contemplated that Bluetooth and 802.11 technologies can be used.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. An alarm system for detecting intrusion into a premises having telephone service to at least one telephone over a telephone line, comprising:
a plurality of wireless sensors arranged in an area to be monitored for generating unique coded wireless signals indicating an alarm condition upon detection of an intrusion; and
an alarm module connected to said telephone line for detecting said unique coded wireless signals and in response providing a notification over said telephone line of said alarm condition on a specified one of said sensors.

2. The alarm system of claim 1 wherein said plurality of wireless sensors are radio frequency identification (RFID) devices.

3. The alarm system of claim 1 wherein said plurality of wireless sensors are Bluetooth devices.

4. The alarm system of claim 1 wherein said plurality of wireless sensors are 802.11 devices.

5. The alarm system of claim 2, 3 or 4, wherein each of said sensors includes an alarm switch for activating generation of said unique coded wireless signals in response to said alarm switch being actuated by an intruder.

6. The alarm system of claim 2, 3 or 4, wherein each of said sensors includes a self-test switch for activating generation of said unique coded wireless signals in response to said self-test switch being actuated by a user thereby verifying detection of respective ones of said sensors by said alarm module.

7. The alarm system of claim 1 wherein said alarm module includes a ringing generator for causing said at least one telephone to ring according to a predetermined pattern indicating said alarm condition.

8. The alarm system of claim 1 wherein said alarm module includes a tone generator for generating an audible signal over said at least one telephone indicating said specified one of said sensors.

9. The alarm system of claim 1 wherein said alarm module includes a speech generation system for providing a spoken alarm message over said at least one telephone indicating said specified one of said sensors.

10. The alarm system of claim 1 wherein said alarm module includes an alarm call generator for placing a telephone call outside of said premises to provide notification of said alarm condition on said specified one of said sensors via one of either a speech generation system for providing a spoken alarm message or a tone generator for generating an audible signal.

11. The alarm system of claim 1 wherein said alarm module includes a DTMF tone detector to facilitate programming of said module and dialer functionality over said at least one telephone.

12. The alarm system of claim 1 wherein said alarm module is connected to said telephone line where the line enters said premises.

13. The alarm system of claim 1 wherein said alarm module is integrated with said at least one telephone and connected to said telephone line within said premises.

14. The alarm system of claim 1 wherein said alarm module is connected between said at least one telephone and said telephone line within said premises.

15. Method of programming the alarm system of claim 6, comprising:
detecting within said alarm module user entry of a predetermined DTMF code in said at least one telephone;
signaling an acknowledgement of said DTMF code by said alarm module to said at least one telephone;
generation of a said unique coded wireless signal at said specified one of said sensors responsive to actuation of said self-test switch; and
detecting said unique coded wireless signal within said alarm module and in response enabling further detection of said unique coded wireless signals for indicating said alarm condition.

16. The method of claim 15 wherein said signaling of the acknowledgement of said DTMF code comprises generation of an audible signal.

17. The method of claim 16 wherein said audible signal is a pattern of tone beeps.

18. The method of claim 16 wherein said audible signal is a voiced communication.

19. A method of operating an alarm system to provide persistent filtering, comprising:
arming at least one alarm sensor capable of generating a unique coded signal indicating an alarm condition;
monitoring said at least one alarm sensor for said unique coded signal; and
indicating an alarm condition in the event that said alarm condition persists for a predetermined period of time.

20. A method of operating an alarm system to provide activity filtering, comprising:
arming at least one alarm sensor capable of generating a unique coded signal indicating an alarm condition;
monitoring said at least one alarm sensor for said unique coded signal and determining a rate of generation of said unique coded signal; and
indicating an alarm condition in the event that said rate of generation of said unique coded signal falls below a predetermined rate.

21. A method of operating an alarm system to provide timed activity filtering, comprising:
arming at least one alarm sensor capable of generating a unique coded signal indicating an alarm condition;
monitoring said at least one alarm sensor for said unique coded signal; and
indicating an alarm condition in the absence of generation of said unique coded signal within a predetermined time interval.

22. A method of operating an ancillary alarm system connected to a primary alarm system, comprising:
arming at least one wireless alarm sensor capable of generating a unique coded signal indicating an alarm condition;
monitoring said at least one alarm sensor for said unique coded signal; and
transmitting an alarm signal to said primary alarm system upon detecting said unique coded signal.
